(19) United States
(12) Patent Application Publication
(10) Pub. No.: US 2020/0032673 A1
(43) Pub. Date: Jan. 30, 2020

(54) CASING ARRANGEMENT FOR AN AXIAL COMPRESSOR OF A GAS TURBINE ENGINE

(71) Applicant: Rolls-Royce Deutschland Ltd & Co KG, Blankenfelde-Mahlow (DE)

(72) Inventors: Robert KWIATKOWSKI, Berlin (DE); Oliver KÖHNE, Berlin (DE)

(21) Appl. No.: 16/437,925

(22) Filed: Jun. 11, 2019

(30) Foreign Application Priority Data
Jun. 12, 2018 (DE) 10 2018 113 997.7

(51) Int. Cl. F01D 25/24; F01D 9/04

(52) U.S. Cl. CPC F01D 25/24; F01D 9/042; F04D 29/526; F05D 2260/38; F05D 2240/14

(57) ABSTRACT

The invention relates to a casing assembly for an axial compressor of a gas turbine engine, wherein the casing assembly comprises a compressor casing which has a plurality of annular casings which in the axial direction are mutually contiguous by way of screwless interfaces and which are connected to one another by a clamping force. It is provided that the casing assembly comprises a clamping spring which provides the clamping force for connecting the annular casings, wherein the clamping spring is disposed and positioned in such a manner that said clamping spring is not part of a load path of the gas turbine.

This application claims priority to German Patent Application DE102018113997.7 filed Jun. 12, 2018, the entirety of which is incorporated by reference herein.

The invention relates to a casing assembly for an axial compressor of a gas turbine engine, according to the preamble of patent claim 1.

The compressor casing of an axial compressor typically comprises a plurality of annular casings which in the axial direction are screw-fitted to one another by means of flange connections. It is known from U.S. Pat. No. 8,613,593 B2 for the individual annular casings to be connected to one another by way of a clamping force, without screw connections or the like being used. The clamping force herein is provided by one or a plurality of casings which runs/run so as to be parallel to the annular casings and so as to be radially outside the latter and which act as a spring or springs, respectively, which exerts/exert a spring force on the axially frontmost annular casing and the axially rearmost annular casing. The casings acting as a spring herein are configured so as to be in the load path of the gas turbine in which the axial compressor is disposed.

The invention is based on the object of providing a casing assembly for an axial compressor in which a clamping force is introduced into the compressor casing in an effective manner.

This object is achieved by a casing assembly having the features of claim 1 and by a casing assembly having the features of claim 11. Design embodiments of the invention are set forth in the dependent claims.

The invention proceeds from a casing assembly for an axial compressor of a gas turbine engine, wherein the casing assembly comprises a compressor casing which has a plurality of annular casings which in the axial direction are mutually contiguous by way of screwless interfaces and which are connected to one another by a clamping force. Screwless interfaces herein are understood to be interfaces which make do without any screws, bolts, or the like. According to a first aspect of the invention it is provided that a clamping spring is provided for providing the clamping force for connecting the annular casings, said clamping spring being disposed and positioned in such a manner that said clamping spring is not part of a load path of the gas turbine. The clamping spring herein is a part that is separate from the annular casings.

On account of the clamping spring not being part of a load path of the gas turbine it is possible for the clamping spring to be designed and dimensioned independently of supporting elements of the load path such as, for example, casing structures that are integrated in the load path. The possibilities in terms of the design and in terms of the disposal of the clamping spring are improved on account thereof. For example, the clamping spring can be configured so as to have a light weight. A further advantage results on account of a simplified assembly operation since no connection that transfers a spring force between the individual annular casings and elements of the load path is necessary.

A load path herein is formed by load-bearing structures which absorb axial and radial loads that are generated by the weight of the gas turbine and/or by the operation of the latter, and transmit said loads to a pylon or to another engine mount, for example. Structures situated in the load path are in particular bearings, stanchions, and casing structures.

One design embodiment of the invention provides that the clamping spring is configured and positioned in such a manner that said clamping spring introduces the clamping force into the compressor casing exclusively in the axial direction or counter to the axial direction. The axial direction is defined by the machine axis, wherein said axial direction is directed from the engine inlet in the direction of the engine outlet. As opposed to the case in U.S. Pat. No. 8,613,593 B2, for example, the clamping force is thus introduced to the axially rearmost annular casing or the axially frontmost annular casing by way of only one directional component, specifically in the axial direction or counter to the axial direction. The clamping force is introduced from one end and not from both ends of the annular casings that are connected to one another.

Accordingly, one design embodiment of the invention provides an axial support which provides the counterforce for the clamping force, wherein the axial support does not exert any spring forces on the annular casings but only provides the counterforce for the clamping force. It can be provided herein that the axial support, when the clamping force acts on the axially rearmost annular casing, is provided by the axially frontmost annular casing or a component of the gas turbine that is contiguous or connected to said axially frontmost annular casing or, when the clamping force acts on the axially frontmost annular casing, is provided by the axially rearmost annular casing or a component of the gas turbine that is contiguous or connected to said axially rearmost annular casing.

One further design embodiment of the invention provides that the clamping spring is configured as a disk spring. Such a design embodiment of the clamping spring in an effective manner permits forces that act in the axial direction, or counter to the axial direction, respectively, to be exerted on the axially frontmost or axially rearmost annular casing.

One design embodiment of the invention herein provides that the disk spring on a radially inward portion configures a radially extending end face which bears on a radially extending end face of the contiguous annular casing such that the axially acting clamping force can be transmitted by way of the two end faces.

One further design embodiment provides that the disk spring on a radially outward portion configures a flange by way of which said disk spring by means of a flange connection is connected to a casing structure which is configured so as to be radially outside the annular casings. The flange connection herein, in terms of the axial position thereof, is configured so as to be downstream of, thus axially behind, the axially rearmost annular casing. The casing structure mentioned, which is configured radially outside the annular casings, can be a casing structure that is disposed in a load path. Said casing structure can comprise one or a plurality of outer casings which have a diameter that is larger than the annular casings.

According to one design embodiment, the flange configured by the disk spring runs substantially in the radial direction, wherein the connection to the casing structure provides an axial support of the disk spring.

Furthermore, one design embodiment of the invention can provide that the disk spring in the radial direction delimits and seals an annular space at the axially rearward end thereof, said annular space extending between at least some of the annular casings and the casing structure which is configured radially outside the annular casings. On account thereof, the disk spring fulfills an additional sealing function.

According to a second aspect of the invention, a casing assembly for an axial compressor of a gas turbine engine is provided in which the clamping force for connecting the annular casings is generated by a clamping spring configured as a disk spring. The disk spring herein is configured and positioned in such a manner that said disk spring introduces the clamping force into the compressor casing exclusively in the axial direction or counter to the axial direction. The disk spring herein is a part that is separate from the annular casings.

The disk spring herein exerts a clamping force on the axially rearmost annular casing or the axially frontmost annular casing. An axial support which provides the counterforce for the clamping force of the disk spring is disposed on the axially opposite end of the axial assembly of annular casings. This axial support herein does not exert any spring forces on the neighboring annular casing, that is to say that the spring force introduced acts only in one direction (in the axial direction or counter to the axial direction).

Further design embodiments of the invention provide that the annular casings have in each case radially running end faces as screwless interfaces. The force transmission between two annular casings is thus performed by way of mutually contiguous end faces that in each case run radially. In principle, however, it is likewise possible for the end sides of the individual annular casings to be additionally secured in relation to a radial relative movement by way of mutually engaging structures such as protrusions and recesses.

One further design embodiment of the invention provides that the casing assembly has means for a blade tip gap check, said blade tip gap check providing an optimization of the gap between the blade tips of a rotor that is surrounded by the respective annular casing and the internal wall of the annular casing. A further advantage of the solution according to the invention herein lies in that, by virtue of the absence of the necessity of connecting the individual annular casings to one another by way of screw connections, the temperature change of the annular casings that is necessary for a blade tip gap check can be implemented in a simpler and more effective manner by virtue of a smaller flow-washed surface (absence of the screw heads/bolt heads and nuts) and of an increased degree of freedom in terms of construction of the annular casings. In particular, the ratio between the face by way of which a thermal transmission for the blade tip gap check is performed and the mass that is to be changed in terms of temperature can be optimized on account of the improved degree of freedom in terms of construction.

The invention in a further aspect thereof relates to a gas turbine engine having a compressor casing according to claim 1 or claim 11.

It can be provided herein that the gas turbine engine has:
an engine core which comprises a turbine, a compressor having a casing assembly according to claim 1 or according to claim 11, and a turbine shaft which is configured as a hollow shaft and connects the turbine to the compressor;
a fan which is positioned upstream of the engine core, wherein the fan comprises a plurality of fan blades; and
a gearbox that receives an input from the turbine shaft and outputs drive to the fan so as to drive the fan at a lower rotational speed than the turbine shaft.

One design embodiment to this end can provide that
the turbine is a first turbine, the compressor is a first compressor, and the turbine shaft is a first turbine shaft;
the engine core further comprises a second turbine, a second compressor, and a second turbine shaft which connects the second turbine to the second compressor; and
the second turbine, the second compressor, and the second turbine shaft are disposed with a view to rotating at a higher rotational speed than the first turbine shaft.

It is pointed out that the present invention, to the extent that the latter relates to an aircraft gas turbine, is described with reference to a cylindrical coordinate system which has the coordinates x, r, and φ. Herein x indicates the axial direction, r indicates the radial direction, and φ indicates the angle in the circumferential direction. The axial direction herein is defined by the rotation axis of the planetary gearbox, said rotation axis being identical to a machine axis of a gearbox fan engine in which the planetary gearbox is disposed. Proceeding from the x-axis, the radial direction points radially outwards. Terms such as “in front of”, “behind”, “front”, and “rear” refer to the axial direction, or the flow direction in the engine in which the planetary gearbox is disposed, respectively. Terms such as “outer” or “inner” refer to the radial direction.

As noted elsewhere herein, the present disclosure can relate to a gas turbine engine. Such a gas turbine engine may comprise an engine core which comprises a turbine, a combustion chamber, a compressor, and a core shaft that connects the turbine to the compressor. Such a gas turbine engine can comprise a fan (having fan blades) which is positioned upstream of the engine core.

Arrangements of the present disclosure can be particularly, although not exclusively, beneficial for fans that are driven via a gearbox. Accordingly, the gas turbine engine can comprise a gearbox that receives an input from the core shaft and outputs drive to the fan so as to drive the fan at a lower rotational speed than the core shaft. The input to the gearbox can be performed directly from the core shaft or indirectly from the core shaft, for example via a spur shaft and/or a spur gear. The core shaft can be rigidly connected to the turbine and the compressor, such that the turbine and the compressor rotate at the same rotational speed (wherein the fan rotates at a lower rotational speed).

The gas turbine engine as described and/or claimed herein can have any suitable general architecture. For example, the gas turbine engine can have any desired number of shafts, for example one, two or three shafts, that connect turbines and compressors. Purely by way of example, the turbine connected to the core shaft can be a first turbine, the compressor connected to the core shaft can be a first compressor, and the core shaft can be a first core shaft. The engine core can further comprise a second turbine, a second compressor, and a second core shaft which connects the second turbine to the second compressor. The second turbine, the second compressor, and the second core shaft can be disposed with a view to rotating at a higher rotational speed than the first core shaft.

In such an arrangement, the second compressor can be positioned so as to be axially downstream of the first compressor. The second compressor can be disposed with a view to receiving (for example directly receiving, for example by way of a generally annular duct) flow from the first compressor.

The gearbox can be disposed with a view to being driven by the core shaft (for example the first core shaft in the example above) which is configured to rotate (for example when in use) at the lowest rotational speed. For example, the gearbox can be disposed with a view to being driven only by the core shaft (for example only by the first core shaft, and not the second core shaft, in the example above) that is configured to rotate (for example when in use) at the lowest rotational speed. Alternatively thereto, the gearbox can be disposed with a view to being driven by one or a plurality of shafts, for example the first and/or the second shaft in the example above.

In the case of a gas turbine engine as described and/or claimed herein, a combustion chamber can be provided axially downstream of the fan and of the compressor(s). For example, the combustion chamber can lie directly downstream of the second compressor (for example at the exit of the latter), when a second compressor is provided. By way of further example, the flow at the exit to the compressor can be provided to the inlet of the second turbine, when a second turbine is provided. The combustion chamber can be provided so as to be upstream of the turbine(s).

The or each compressor (for example the first compressor and the second compressor as described above) can comprise any number of stages, for example multiple stages. Each stage can comprise a row of rotor blades and a row of stator vanes, which may be variable stator vanes (in the sense that the angle of incidence of said variable stator vanes can be variable). The row of rotor blades and the row of stator vanes can be axially offset from each other.

The or each turbine (for example the first turbine and the second turbine as described above) can comprise any number of stages, for example multiple stages. Each stage can comprise a row of rotor blades and a row of stator vanes. The row of rotor blades and the row of stator vanes can be axially offset from each other.

Each fan blade can be defined as having a radial span extending from a root (or a hub) at a radially inner gas-washed location, or a 0% span position in relation to a tip at a 100% span position. The ratio of the radius of the fan blade at the hub to the radius of the fan blade at the tip can be less than (or in the magnitude of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip can be in an inclusive range delimited by two of the values in the previous sentence (that is to say that the values can form upper or lower limits). These ratios can commonly be referred to as the hub-to-tip ratio. The radius at the hub and the radius at the tip can both be measured at the leading periphery (or the axially frontmost periphery) of the blade. The hub-to-tip ratio refers, of course, to the gas-washed portion of the fan blade, that is to say the portion that is situated radially outside any platform.

The radius of the fan can be measured between the engine centerline and the tip of the fan blade at the leading periphery of the latter. The diameter of the fan (said diameter potentially simply being double the radius of the fan) can be larger than (or in the magnitude of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter can be in an inclusive range delimited by two of the values in the previous sentence (that is to say that the values can form upper or lower limits).

The rotational speed of the fan can vary when in use. Generally, the rotational speed is lower for fans with a comparatively large diameter. Purely by way of non-limiting example, the rotational speed of the fan at constant speed conditions can be less than 2500 rpm, for example less than 2300 rpm. Purely by way of further non-limiting example, the rotational speed of the fan at constant speed conditions for an engine having a fan diameter in the range from 250 cm to 300 cm (for example 250 cm to 280 cm) can also be in the range from 1700 rpm to 2500 rpm, for example in the range from 1800 rpm to 2300 rpm, for example in the range from 1900 rpm to 2100 rpm. Purely by way of further non-limiting example, the rotational speed of the fan at constant speed conditions for an engine having a fan diameter in the range from 320 cm to 380 cm can be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about a rotation axis. This rotation results in the tip of the fan blade moving with a speed Uₜᵢₚ. The work done by the fan blades on the flow results in an enthalpy rise dH in the flow. A fan tip loading can be defined as dH/Uₜᵢₚ², where dH is the enthalpy rise (for example the 1-D average enthalpy rise) across the fan and Uₜᵢₚ is the (translational) velocity of the fan tip, for example at the leading periphery of the tip (which can be defined as the fan tip radius at the leading periphery multiplied by the angular speed). The fan tip loading at constant speed conditions can be more than (or in the magnitude of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²), The fan tip loading can be in an inclusive range delimited by two of the values in the previous sentence (that is to say that the values can form upper or lower limits).

Gas turbine engines in accordance with the present disclosure can have any desired bypass ratio, where the bypass ratio is defined as the ratio of the mass flow rate of the flow through the bypass duct to the mass flow rate of the flow through the core at constant speed conditions. In the case of some arrangements, the bypass ratio can be more than (or in the magnitude of): 10, 10.5, 11, 11.5, 12, 12.5, 13, 13.5, 14, 14.5, 15, 15.5, 16, 16.5, or 17. The bypass ratio can be in an inclusive range delimited by two of the values in the previous sentence (that is to say that the values can form upper or lower limits). The bypass duct can be substantially annular. The bypass duct can be situated radially outside the engine core. The radially outer surface of the bypass duct can be defined by an engine nacelle and/or a fan casing.

The overall pressure ratio of a gas turbine engine as described and/or claimed herein can be defined as the ratio of the stagnation pressure upstream of the fan to the stagnation pressure at the exit of the highest pressure compressor (before entry into the combustion chamber). By way of non-limiting example, the overall pressure ratio of a gas turbine engine as described and/or claimed herein at constant speed can be greater than (or in the magnitude of): 35, 40, 45, 50, 55, 60, 65, 70, 75. The overall pressure ratio can be in an inclusive range delimited by two of the values in the previous sentence (that is to say that the values can form upper or lower limits).

The specific thrust of an engine can be defined as the net thrust of the engine divided by the total mass flow through the engine. The specific thrust of an engine as described and/or claimed herein at constant speed conditions can be less than (or in the magnitude of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust can be in an inclusive range delimited by two of the values in the previous sentence (that is to say that the values can form upper or lower limits). Such engines can be particularly efficient in comparison with conventional gas turbine engines.

A gas turbine engine as described and/or claimed herein can have any desired maximum thrust. Purely by way of non-limiting example, a gas turbine as described and/or claimed herein can be capable of generating a maximum thrust of at least (or in the magnitude of): 160 kN, 170 kN, 180 kN, 190 kN, 200 kN, 250 kN, 300 kN, 350 kN, 400 kN, 450 kN, 500 kN, or 550 kN. The maximum thrust can be in an inclusive range delimited by two of the values in the previous sentence (that is to say that the values can form upper or lower limits). The thrust referred to above can be the maximum net thrust at standard atmospheric conditions at sea level plus 15 degrees C. (ambient pressure 101.3 kPa, temperature 30 degrees C.), at a static engine.

In use, the temperature of the flow at the entry to the high pressure turbine can be particularly high. This temperature, which can be referred to as TET, can be measured at the exit to the combustion chamber, for example directly upstream of the first turbine vane, which in turn can be referred to as a nozzle guide vane. At constant speed, the TET can be at least (or in the magnitude of): 1400K, 1450K, 1500K, 1550K, 1600K, or 1650K. The TET at constant speed can be in an inclusive range delimited by two of the values in the previous sentence (that is to say that the values can form upper or lower limits). The maximum TET in the use of the engine can be at least (or in the magnitude of), for example: 1700K, 1750K, 1800K, 1850K, 1900K, 1950K, or 2000K. The maximum TET can be in an inclusive range delimited by two of the values in the previous sentence (that is to say that the values can form upper or lower limits). The maximum TET can occur, for example, at a high thrust condition, for example at a maximum take-off thrust (MTO) condition.

A fan blade and/or an airfoil portion of a fan blade described and/or claimed herein can be manufactured from any suitable material or a combination of materials. For example, at least a part of the fan blade and/or of the airfoil can be manufactured at least in part from a composite, for example a metal matrix composite and/or an organic matrix composite, such as carbon fiber. By way of further example, at least a part of the fan blade and/or of the airfoil can be manufactured at least in part from a metal, such as a titanium-based metal or an aluminum-based material (such as an aluminum-lithium alloy) or a steel-based material. The fan blade can comprise at least two regions which are manufactured using different materials. For example, the fan blade can have a protective leading periphery, which is manufactured using a material that is better able to resist impact (for example from birds, ice, or other material) than the rest of the blade. Such a leading periphery can, for example, be manufactured using titanium or a titanium-based alloy. Thus, purely by way of example, the fan blade can have a carbon-fiber- or aluminum-based body (such as an aluminum-lithium alloy) with a titanium leading periphery.

A fan as described and/or claimed herein can comprise a central portion, from which the fan blades can extend, for example in a radial direction. The fan blades can be attached to the central portion in any desired manner. For example, each fan blade can comprise a fixing device which can engage with a corresponding slot in the hub (or disk). Purely by way of example, such a fixing device can be in the form of a dovetail that can slot into and/or engage with a corresponding slot in the hub/disk in order for the fan blade to be fixed to the hub/disk. By way of further example, the fan blades can be formed integrally having a central portion. Such an arrangement can be referred to as a blisk or a bling. Any suitable method can be used to manufacture such a blisk or bling. For example, at least a part of the fan blades can be machined from a block and/or at least a part of the fan blades can be attached to the hub/disk by welding, such as linear friction welding, for example.

The gas turbine engines described and/or claimed herein may or may not be provided with a variable area nozzle (VAN). Such a variable area nozzle can allow the exit cross section of the bypass duct to be varied when in use. The general principles of the present disclosure can apply to engines with or without a VAN.

The fan of a gas turbine as described and/or claimed herein can have any desired number of fan blades, for example 16, 18, 20, or 22 fan blades.

As used herein, constant speed conditions can mean constant speed conditions of an aircraft to which the gas turbine engine is attached. Such constant speed conditions can be conventionally defined as the conditions at mid-cruise, for example the conditions experienced by the aircraft and/or the engine at the midpoint between (in terms of time and/or distance) the top of climb and the start of descent.

Purely by way of example, the forward speed at the constant speed condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example in the magnitude of Mach 0.8, in the magnitude of Mach 0.85 or in the range of from 0.8 to 0.85. Any arbitrary speed within these ranges can be the constant cruise condition. In the case of some aircraft, the constant cruise conditions can be outside these ranges, for example below Mach 0.7 or above Mach 0.9.

Purely by way of example, the constant speed conditions can correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example in the magnitude of 11,000 m. The constant speed conditions can correspond to standard atmospheric conditions at any given altitude in these ranges.

Purely by way of example, the constant speed conditions can correspond to the following: a forward Mach number of 0.8; a pressure of 23,000 Pa; and a temperature of −55 degrees C.

As used anywhere herein, “constant speed” or “constant speed conditions” can mean the aerodynamic design point. Such an aerodynamic design point (or ADP) can correspond to the conditions (including, for example, the Mach number, environmental conditions, and thrust requirement) for which the fan operation is designed. This can mean, for example, the conditions at which the fan (or the gas turbine engine) in terms of construction has optimum efficiency.

In use, a gas turbine engine described and/or claimed herein can operate at the constant speed conditions defined elsewhere herein. Such constant speed conditions can be determined by the constant speed conditions (for example the mid-cruise conditions) of an aircraft to which at least one (for example 2 or 4) gas turbine engine can be fastened in order for the thrust force to be provided.

It is self-evident to a person skilled in the art that a feature or parameter described in relation to one of the above aspects can be applied to any other aspect, unless they are mutually exclusive. Furthermore, any feature or any parameter described here can be applied to any aspect and/or combined with any other feature or parameter described here, unless they are mutually exclusive.

The invention will be explained in more detail hereunder by means of a plurality of exemplary embodiments with reference to the figures of the drawing. In the drawing:

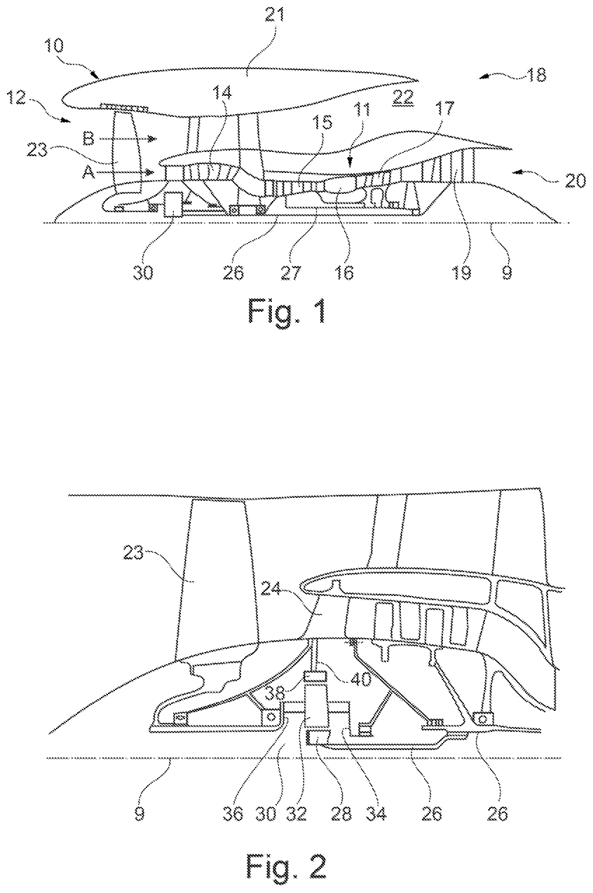

FIG. 1 shows a sectional lateral view of a gas turbine engine;

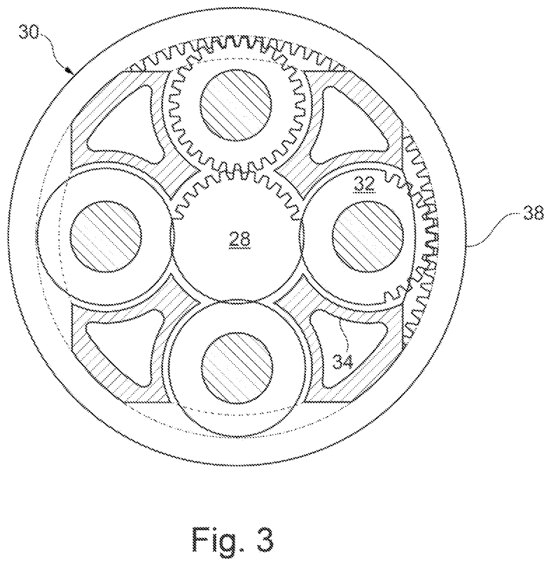

FIG. 2 shows a close-up sectional lateral view of an upstream portion of a gas turbine engine;

FIG. 3 shows a partially cut-away view of a gearbox for a gas turbine engine;

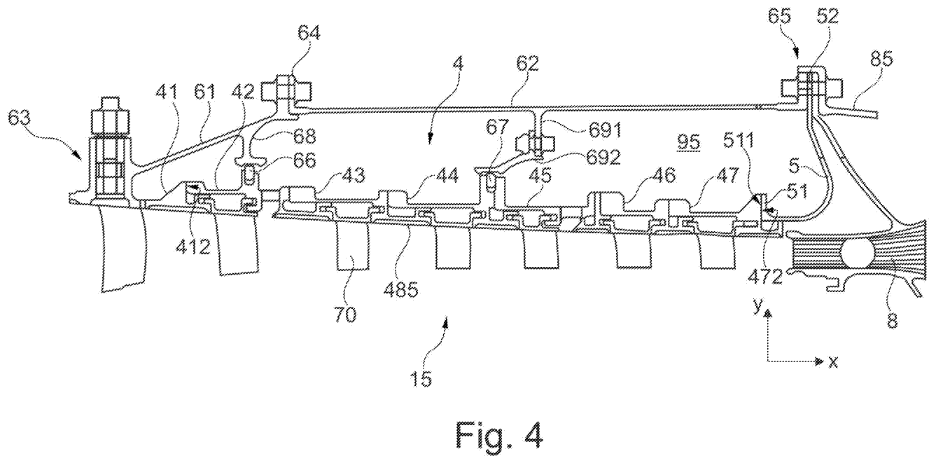

FIG. 4 schematically shows in an axial sectional illustration a casing assembly having a compressor casing which comprises a plurality of annular casings which are connected to one another by a clamping force exerted by a disk spring;

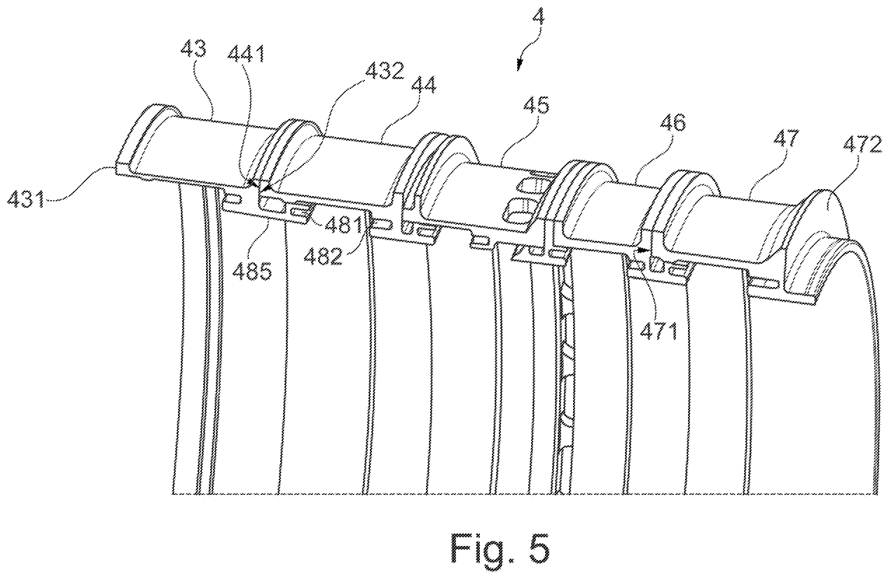

FIG. 5 shows an enlarged illustration of axially mutually contiguous annular casings according to FIG. 4; and

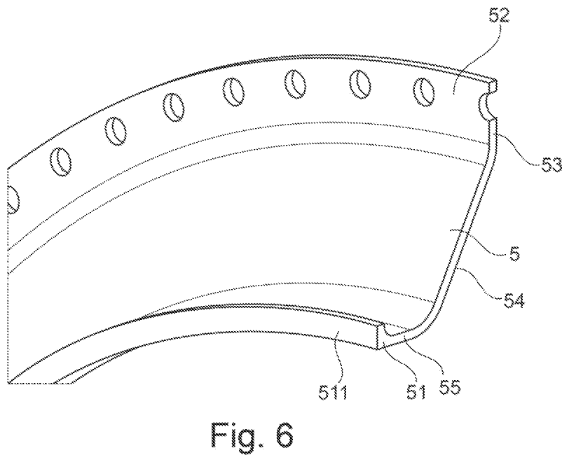

FIG. 6 shows in a perspective illustration an exemplary embodiment of a disk spring in a casing assembly according to FIG. 4.

FIG. 1 illustrates a gas turbine engine 10 having a principal rotational axis 9. The engine 10 comprises an air intake 12 and a thrust fan 23 that generates two airflows: a core airflow A and a bypass airflow B. The gas turbine engine 10 comprises a core 11 which receives the core airflow A. In the sequence of axial flow, the engine core 11 comprises a low-pressure compressor 14, a high-pressure compressor 15, a combustion installation 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass airflow B flows through the bypass duct 22. The fan 23 is attached to and driven by the low pressure turbine 19 by way of a shaft 26 and an epicyclic gearbox 30.

When in use, the core airflow A is accelerated and compressed by the low-pressure compressor 14 and directed into the high-pressure compressor 15 where further compression takes place. The compressed air exhausted from the high-pressure compressor 15 is directed into the combustion device 16, where it is mixed with fuel and the mixture is combusted. The resultant hot combustion products then expand through, and thereby drive, the high-pressure and low-pressure turbines 17, 19 before being exhausted through the nozzle 20 to provide some thrust force. The high-pressure turbine 17 drives the high-pressure compressor 15 by means of a suitable connection shaft 27. The fan 23 generally provides the majority of the thrust force. The epicyclic gearbox 30 is a reduction gearbox.

An exemplary assembly for a gearbox fan gas turbine engine 10 is shown in FIG. 2. The low-pressure turbine 19 (see FIG. 1) drives the shaft 26, which is coupled to a sun gear 28 of the epicyclic gearbox assembly 30. Radially outwardly of the sun gear 28 and meshing therewith are a plurality of planet gears 32 that are coupled to one another by a planet carrier 34. The planet carrier 34 limits the planet gears 32 to orbiting around the sun gear 28 in a synchronous manner whilst enabling each planet gear 32 to rotate about its own axis. The planet carrier 34 by way of linkages 36 is coupled to the fan 23 with a view to driving the rotation of the latter about the engine axis 9. Radially outwardly of the planet gears 32 and meshing therewith is an annulus or ring gear 38 that is coupled, via linkages 40, to a stationary supporting structure 24.

It is noted that the terms “low-pressure turbine” and “low-pressure compressor” as used herein can be taken to mean the lowest pressure turbine stage and the lowest pressure compressor stage (that is to say not including the fan 23) respectively and/or the turbine and compressor stages that are connected to one another by the connecting shaft 26 with the lowest rotational speed in the engine (that is to say not including the gearbox output shaft that drives the fan 23). In some literature, the “low-pressure turbine” and the “low-pressure compressor” referred to herein can alternatively be known as the “intermediate pressure turbine” and “intermediate-pressure compressor”. Where such alternative nomenclature is used, the fan 23 can be referred to as a first, or lowest pressure, compression stage.

The epicyclic gearbox 30 is shown in an exemplary manner in greater detail in FIG. 3. Each of the sun gear 28, the planet gears 32 and the ring gear 38 comprise teeth about their periphery to mesh with the other gears. However, for clarity only exemplary portions of the teeth are illustrated in FIG. 3. There are four planet gears 32 illustrated, although it will be apparent to the person skilled in the art that more or fewer planet gears 32 can be provided within the scope of protection of the claimed invention. Practical applications of an epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, wherein the ring gear 38 is fixed. However, any other suitable type of epicyclic gearbox 30 can be used. By way of further example, the epicyclic gearbox 30 can be a star arrangement, in which the planet carrier 34 is held so as to be fixed, wherein the ring gear (or annulus) 38 is allowed to rotate. In the case of such an arrangement, the fan 23 is driven by the ring gear 38. By way of further alternative example, the gearbox 30 can be a differential gearbox in which the ring gear 38 and the planet carrier 34 are both allowed to rotate.

It goes without saying that the arrangement shown in FIGS. 2 and 3 is by way of example only, and various alternatives are within the scope of protection of the present disclosure. Purely by way of example, any suitable arrangement can be used for positioning the gearbox 30 in the engine 10 and/or for connecting the gearbox 30 to the engine 10. By way of further example, the connections (such as the linkages 36, 40 in the example of FIG. 2) between the gearbox 30 and other parts of the engine 10 (such as the input shaft 26, the output shaft and the fixed structure 24) can have a certain degree of stiffness or flexibility. By way of further example, any suitable arrangement of the bearings between rotating and stationary parts of the engine (for example between the input and output shafts of the gearbox and the fixed structures, such as the gearbox casing) can be used, and the disclosure is not limited to the exemplary arrangement of FIG. 2. For example, where the gearbox 30 has a star arrangement (described above), the person skilled in the art would readily understand that the arrangement of output and support linkages and bearing positions would typically be different to that shown by way of example in FIG. 2.

Accordingly, the present disclosure extends to a gas turbine engine having an arbitrary arrangement of gearbox types (for example star-shaped or planetary), support structures, input and output shaft arrangement, and bearing positions.

Optionally, the gearbox can drive additional and/or alternative components (e.g. the intermediate pressure compressor and/or a booster compressor).

Other gas turbine engines to which the present disclosure can be applied can have alternative configurations. For example, engines of this type can have an alternative number of compressors and/or turbines and/or an alternative number of connecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure can also apply to engines in which the flow through the bypass duct 22 and the flow through the core 11 are mixed, or combined, before (or upstream of) a single nozzle, which can be referred to as a mixed flow nozzle. One or both nozzles (whether mixed or split flow) can have a fixed or variable area. Whilst the example described relates to a turbofan engine, the disclosure can be applied, for example, to any type of gas turbine engine, such as, for example, an open rotor (in which the fan stage is not surrounded by an engine nacelle) or a turboprop engine. In some assemblies, the gas turbine engine 10 may not comprise a gearbox 30.

The geometry of the gas turbine engine 10, and components thereof, is/are defined by a conventional axis system, comprising an axial direction (which is aligned with the rotational axis 9), a radial direction (in the bottom-to-top direction in FIG. 1), and a circumferential direction (perpendicular to the view in FIG. 1). The axial, radial and circumferential directions are mutually perpendicular.

The configuration of the casing of the low-pressure compressor 14 or of the high-pressure compressor 15 is significant in the context of the present invention, wherein the observed casing delimits the core air flow through the core engine in a radially outward manner. The invention herein is described hereunder by means of the casing of the high-pressure compressor 15. The housing of any other compressor can also be configured in an analogous manner.

FIG. 4 in an exemplary manner shows a high-pressure compressor 15. The high-pressure compressor 15 has a casing assembly having a compressor casing 4 which delimits the annular space, or the flow duct through the high-pressure compressor 15, respectively, in a radially outward manner. The compressor casing 4 comprises a plurality of annular casings 41-47 which are contiguous in the axial direction x and are in each case configured so as to be annular (wherein said annular casings 41-47 can be formed in one part or from interconnected segments). As is described in detail by means of FIG. 5, the individual annular casings 41-47 are connected to one another by way of screwless interfaces which are formed by end faces that run in the radial direction r. The flow duct behind the high-pressure compressor 15 transitions to a portion 8 which is fed to the combustion chamber of the gas turbine (not illustrated).

The high-pressure compressor 15 has a plurality of stator vanes 70 which are fastened to the compressor casing 4. Not illustrated are a plurality of rotor blades which are disposed between the stator vanes 70, wherein one rotor blade and one stator vane 70 form in each case one compressor stage. The blade tips of the rotor blades herein are contiguous to portions 485 of the annular casings 41-47, said portions 485 for minimizing the gap between the blade tips and the internal side of the annular casings 41-47 that delimits the flow path potentially being provided with an inlet coating.

It is pointed out that the individual annular casings 41-47 are not necessarily of identical configuration. In particular, some of the annular casings can be adapted with a view to, for example, configuring openings for bleed air, structures for passive or active blade tip gap control (tip clearance control), and/or structures for connecting to or receiving further components.

The casing assembly comprises further casing structures which extend in the axial direction and which in relation to the annular casings 41-47 have a larger diameter and accordingly extend radially outside the annular casings 41-47. Said further casing structures herein run so as to be substantially parallel to the annular casings 41-47. Said further casing structures are a first outer casing portion 61 and a second outer casing portion 62. Said outer casing portions 61, 62 can likewise be configured so as to be continuous such that said outer casing portions 61, 62 extend across 360°.

The first outer casing portion 61 at the axially front end thereof is connected to the axially frontmost annular casing 41 of the annular casings 41-47 by means of a connection device 63 which is formed by a flange connection, for example. The first outer casing portion 61 at the axially rearward end thereof is connected to an axially front end of the second outer casing portion 62 by way of a flange connection 64. The second outer casing portion 62 furthermore configures an axially rearward end which in a flange connection 65 is connected to a clamping spring 5 and further structures 85.

The first outer casing portion 61 comprises a radially inward extending wall portion 68 on which a seal 66 that is disposed on the one annular casing 42 bears. In an analogous manner, the second casing portion 62 comprises a radially inward extending wall portion 691, 692 on which a seal 67 that is disposed between two annular casings 44, 45 bears. On account thereof, different regions of the casing are separated from one another in terms of the air pressure prevalent therein.

The two outer casing portions 61, 62 form part of a load path of the gas turbine, that is to say that said two outer casing portions 61, 62 transmit forces that engage on the gas turbine, or are generated by the gas turbine, respectively, to an engine mount or the like.

The individual annular casings 41-47 are connected to one another by a clamping force. The clamping force is provided by the clamping spring 5 which has already been mentioned and is configured as a disk spring. Said clamping spring 5 in the region of the outer periphery thereof comprises a flange 52 which in the flange connection 65 is connected to the axially rearward flange of the second outer casing 62. The disk spring 5 in the region of the internal periphery thereof furthermore configures a radially extending end face 511. Said radially extending end face 511 bears in a planar manner on an end face 472 of the axially rearmost annular casing 47, said end face 472 extending radially in an analogous manner.

The disk spring 5 is supported in the axial direction on the flange connection 65. Said disk spring 5, on account of the spring force thereof, by way of the end-side connection to the axially rearmost annular casing 47, introduces a spring force acting counter to the axial direction into the series of annular casings 41-47.

The axial support which provides a counterforce for the clamping force provided by the disk spring 5 is provided by a radially extending face 412 of the axially frontmost annular casing 41. The clamping force between the two faces 511, 412 acts on the individual annular casings 41-47 such that the latter are connected to one another in a screwless manner. The interfaces between the annular casings 41-47 herein are in each case provided by radially running end faces.

The forces that are provided onto the annular casings 41-47 by the disk spring 5 depend on the respective construction, in particular on the number of compressor stages and the prevailing pressure ratio. For engines which are used in business jets, said forces are in the range between 80 and 180 kN, in particular in the range between 100 and 145 kN, for example. In the case of larger engines, said forces can however also be significantly higher.

A further function fulfilled by the disk spring 5 can be seen in FIG. 4. Said disk spring 5 at the axially rearward end thus seals the axially rearward annular space 95 between the axially rearward annular casings 45, 46, 47 and the second outer casing portion 62. Said space 95, axially at the front, is sealed by the structures 691, 692, and 67, already explained. This sealing function is enabled on account of the configuration of the spring as a disk spring 5 which continuously comprises material between the internal diameter and the outer diameter of said disk spring 5.

FIG. 5, by means of an exemplary embodiment, shows a plurality of annular casings 43-47 in a partially sectional view. Each annular casing 43-47 has two radially running end faces. This will be explained in an exemplary manner for the axially frontmost annular casing 43 and the axially rearmost annular casing 47. The same applies in an analogous manner to the further annular casings 44, 45, 46.

The axially frontmost annular casing 43 thus comprises an axially forward end face 431 and an axially rearward end face 432. The axially rearward end face 432 is contiguous to a corresponding axially forward end face 441 of the neighboring annular casing 44. The axially rearmost annular casing 47 comprises an axially forward end face 471 and an axially rearward end face 472. By means of the end face 511 of the disk spring (see FIG. 4), a force acting counter to the axial direction is introduced into the connection casing 4 by way of the axially rearward end face 472. On account of the clamping force generated, the individual annular casings 43-47 are connected to one another in a screwless manner, in particular without the configuration of a screw-fitted flange connection.

FIG. 5 furthermore shows recesses 481, 482 which serve for receiving a stator vane. The recesses 481, 482 on neighboring annular casings herein are configured such that one stator vane can in each case be installed when assembling. The annular casings 43-47 furthermore configure portions 485 which radially neighbor the blade tips of the rotors that are disposed in the compressor casing 4. It is provided herein for the radial spacing between the tip of the blade tips and the respective portion 485 to be minimized by way of active or passive blade tip gap control. Such blade tip gap control can be carried out in an effective manner on account of flange connections having a large mass being avoided.

FIG. 6 in an exemplary manner shows an exemplary embodiment of a disk spring 5. It is pointed out that this exemplary embodiment differs from the exemplary embodiment in FIG. 4.

The spring disk 5 comprises a radially outer portion 53 that runs so as to be substantially radial. Said portion 53 configures a flange 52. The disk spring 5 furthermore comprises a radially inner portion 55 that runs substantially in the axial direction. Said portion 55 at the end thereof configures an end portion 51 which has an end face 511 that runs substantially in the radial direction. The disk spring 5 between the two portions 53, 55 has a portion 54 that runs obliquely to the radial direction.

The disk spring 5 for providing an axial support is connected to the second outer casing 62 by means of the flange connection 65 on the flange 52. The end face 511 serves for transmitting the clamping force generated by the disk spring 5 to the annular casings 41-47, cf. FIG. 4.

It goes without saying that the invention is not limited to the above-described embodiments and various modifications and improvements can be made without departing from the concepts described herein. For example, it is provided in the exemplary embodiments described that the spring force acts on the axially rearmost annular casing 47. Alternatively, it can be provided in an analogous manner that the spring force acts on the axially frontmost annular casing 41.

It is furthermore pointed out that any of the features described can be used separately or in combination with any other features, to the extent that said features are not mutually exclusive. The disclosure also extends to and comprises all combinations and sub-combinations of one or a plurality of features which are described here. In as far as ranges are defined, said ranges thus comprise all of the values within said ranges as well as all of the part-ranges that lie in a range.

1. A casing assembly for an axial compressor of a gas turbine engine, wherein the casing assembly comprises a compressor casing which has a plurality of annular casings which in the axial direction are mutually contiguous by way of screwless interfaces and which are connected to one another by a clamping force,
wherein
a clamping spring which provides the clamping force for connecting the annular casings, wherein the clamping spring is disposed and positioned in such a manner that said clamping spring is not part of a load path of the gas turbine.

2. The casing assembly according to claim 1, wherein the clamping spring is configured and positioned in such a manner that said clamping spring introduces the clamping force into the compressor casing exclusively in the axial direction or counter to the axial direction.

3. The casing assembly according to claim 1, wherein the clamping spring is configured and positioned in such a manner that said clamping spring exerts the clamping force on the axially rearmost annular casing or the axial frontmost annular casing.

4. The casing assembly according to claim 1, characterized by an axial support which provides the counterforce for the clamping force, wherein the axial support does not exert any spring forces on the annular casings.

5. The casing assembly according to claim 4, wherein the axial support, when the clamping force acts on the axially rearmost annular casing, is provided by the axially frontmost annular casing or a component of the gas turbine that is contiguous or connected to said axially frontmost annular casing or, when the clamping force acts on the axially frontmost annular casing, is provided by the axially rearmost annular casing or a component of the gas turbine that is contiguous or connected to said axially rearmost annular casing.

6. The casing assembly according to claim 1, wherein the clamping spring is configured as a disk spring.

7. The casing assembly according to claim 6, wherein the disk spring on a radially inward portion configures a radially extending end face which bears on a radially extending end face of the contiguous annular casing.

8. The casing assembly according to claim 6, wherein the disk spring on a radially outward portion configures a flange by way of which said disk spring by means of a flange connection is connected to a casing structure which is configured so as to be radially outside the annular casings.

9. The casing assembly according to claim 8, wherein the disk spring in the radial direction delimits and seals an annular space at the axially rearward end thereof, said annular space extending between at least some of the annular casings and the casing structure.

10. The casing assembly according to claim 8, wherein the flange of the disk spring runs substantially in the radial direction.

11. A casing assembly for an axial compressor of a gas turbine engine, wherein the casing assembly comprises a compressor casing which has a plurality of annular casings which in the axial direction are mutually contiguous by way of screwless interfaces and which are connected to one another by a clamping force,
characterized by
a clamping spring which is configured as a disk spring and which provides the clamping force for connecting the annular casings, wherein the disk spring is configured and positioned in such a manner that said disk spring introduces the clamping force into the compressor casing exclusively in the axial direction or counter to the axial direction.

12. The casing assembly according to claim 11, wherein the disk spring exerts the clamping force on the axially rearmost annular casing or the axially frontmost annular casing.

13. The casing assembly according to claim 11, characterized by an axial support which provides the counterforce for the clamping force, wherein the axial support does not exert any spring forces on the annular casings.

14. The casing assembly according to one of claim 11, wherein the disk spring on a radially inward portion configures a radially extending end face which bears on a radially extending end face of the contiguous annular casing.

15. The casing assembly according to claim 11, wherein the disk spring on a radially outward portion configures a flange by way of which said disk spring by means of a flange connection is connected to a casing structure which is configured so as to be radially outside the annular casings.

16. The casing assembly according to claim 1, wherein the annular casings have in each case radially running end faces as screwless interfaces.

17. The casing assembly according to claim 1, wherein the casing assembly comprises means for a blade tip gap check.

18. The gas turbine engine having a casing assembly according to claim 1.

19. The gas turbine engine according to claim 18, said gas turbine engine having:
an engine core which comprises a turbine, a compressor having the casing assembly, and a turbine shaft which is configured as a hollow shaft and connects the turbine to the compressor;
a fan, which is positioned upstream of the engine core, wherein the fan comprises a plurality of fan blades; and
a gearbox that receives an input from the turbine shaft and outputs drive to the fan so as to drive the fan at a lower rotational speed than the turbine shaft.

20. The gas turbine engine according to claim 19, wherein
the turbine is a first turbine, the compressor is a first compressor, and the turbine shaft is a first turbine shaft;
the engine core further comprises a second turbine, a second compressor, and a second turbine shaft which connects the second turbine to the second compressor; and
the second turbine, the second compressor, and the second turbine shaft are disposed with a view to rotating at a higher rotational speed than the first turbine shaft.
